(19) United States
(12) Patent Application Publication
(10) Pub. No.: US 2005/0044004 A1
(43) Pub. Date: Feb. 24, 2005

(54) System and method for private charter aircraft auction

(76) Inventor: Nathan W. McKelvey, Hingham, MA (US)

Correspondence Address: PALMER & DODGE, LLP;RICHARD B. SMITH, 111 HUNTINGTON AVENUE, BOSTON, MA, 02199, US

(21) Appl. No.: 10/898,396

(22) Filed: Jul. 23, 2004

Related U.S. Application Data
(60) Provisional application No. 60/490,166, filed on Jul. 25, 2003.

(51) Int. Cl. G06F 17/60

(52) U.S. Cl. 705/26

(57) ABSTRACT

In an online private aircraft charter auction, a customer enters a trip itinerary on a customer interface. Available aircraft are determined from a database of available aircraft information. Available aircraft are eliminated to produce a subset of the available aircraft which are suitable candidates for the given trip itinerary. These aircraft providers are alerted to the trip itinerary request and invited to submit a bid on the trip itinerary via a bidding interface.

### RELATED APPLICATIONS

This application claims the benefit of Provisional Application Ser. No. 60/490,166, filed Jul. 25, 2003, the entirety of which is hereby incorporated herein by reference.

### FIELD OF THE INVENTION

Aspects of the present invention relate to aircraft auctions, and more particularly to a system and method for private charter aircraft auction.

### BACKGROUND OF THE INVENTION

There are many types of online auctions on the Internet for a wide range of products. Some of these companies include ebay.com, a person-to-person auction site, and priceline.com, an auction site for travel and related products between customers and travel companies in which the customer places bids on desired items. These websites all have online auction interfaces for one party to enter information regarding the product or service they would like to sell, and for another party to enter a bid on that product or service.

Private charter aircraft auctions pair customers with charter aircraft through online auction systems. By way of example, published U.S. Patent application US2002/0013718A1 discloses a method and system for reserving air charter aircraft. Published U.S. Patent application US2002/0019756A1 discloses a charter aircraft network, organization, reservation, and flight processing system and method. Published U.S. Patent application US2002/0194037A1 discloses a method and apparatus for arranging flexible and cost-efficient private air travel.

### SUMMARY OF THE INVENTION

In accordance with one aspect, the present invention may be directed to a system or method for carrying out a private charter aircraft auction or to any one or combination of parts of such a system or method. Customers access an online auction interface and enter a trip itinerary. Suitable aircraft providers access an online bidding interface and submit bids on the given trip itinerary. A mechanism may be provided to respond to the given trip itinerary by alerting the suitable aircraft providers of an opportunity to submit a bid.

The present invention is a system for auctioning private charter aircraft where customers enter a trip itinerary request and aircraft providers submit bids on the trip itineraries. The system comprises an online auction interface to receive trip itinerary requests from customers and an aircraft availability mechanism to obtain, from an aircraft availability database comprising aircraft availability information, a set of available aircraft and corresponding aircraft providers to serve a given itinerary request. The system also includes a refinement mechanism to eliminate some of the set of available aircraft to produce a smaller set of available aircraft for the given trip itinerary request with eliminated available aircraft being eliminated based on suitability criteria. The system also includes an alert mechanism to alert the aircraft providers corresponding to the smaller set without alerting the aircraft providers corresponding to the eliminated available aircraft. They system includes an online bidding interface to receive a set of bid submissions from a responding set of aircraft providers from among the alerted aircraft providers, the responding set of aircraft providers being those aircraft providers corresponding to the smaller set that voluntarily choose to respond to the alert by accessing the online bidding interface.

The present invention is a method for auctioning private charter aircraft using aircraft availability information where customers enter a trip itinerary request online and aircraft providers submit bids on the trip itineraries comprising: receiving trip itinerary requests from customers at an online auction interface; obtaining a set of available aircraft and corresponding aircraft providers to serve a given trip from an aircraft availability database comprising aircraft availability information; eliminating some of the set of available aircraft based on a suitability criteria to produce a smaller set of available aircraft for the given trip itinerary request; alerting the aircraft providers corresponding to the smaller set without alerting the aircraft providers corresponding to the eliminated available aircraft; and receiving, at an online bidding interface, a set of bid submissions from a responding set of aircraft providers from among the alerted aircraft providers, the responding set of aircraft providers being those aircraft providers corresponding to the smaller set that voluntarily choose to respond to the alert by accessing the online bidding interface.

The present invention is an alert apparatus for alerting aircraft providers when they are a suitable candidate to place online bids in response to a given customer trip itinerary of a private charter aircraft customer. The alert apparatus includes a suitability determination mechanism to determine for a given customer trip itinerary, from a database containing aircraft availability information regarding the availability of private charter aircraft and further based on suitability criteria, a limited set of available aircraft and corresponding aircraft providers. The alert apparatus also includes an alerting mechanism to alert the corresponding aircraft providers, and in the alert invite the corresponding aircraft providers to submit bids on the given customer trip itinerary.

### BRIEF DESCRIPTION OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention.

FIG. 1 is a system diagram of an embodiment of a private charter aircraft auction system.

FIG. 2 is a system diagram of an embodiment of the interaction between a service provider computer system and a database.

FIG. 3 is a diagram of the interaction of systems in a private charter aircraft auction process.

FIG. 4 is a flow diagram of a private charter aircraft auction process.

FIG. 5 is a flow diagram of a refinement process.

FIG. 6 is a block diagram of a representative computer system.

While the above-identified drawings set forth preferred embodiments of the present invention, other embodiments of the present invention are also contemplated, as noted in the discussion. This disclosure presents illustrative embodiments of the present invention by way of representation and not limitation. Numerous other modifications and embodiments can be devised by those skilled in the art which fall within the scope and spirit of the principles of the present invention.

### DETAILED DESCRIPTION

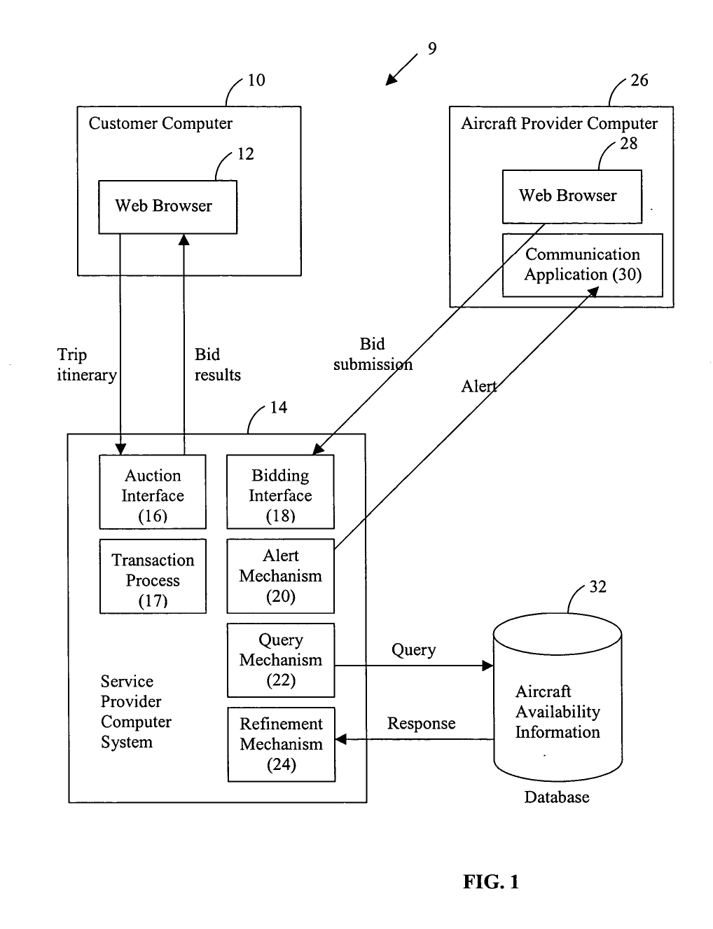

Referring now to the drawings in greater detail, FIG. 1 illustrates a private charter aircraft auction system 9. The illustrated system 9 comprises a service provider computer system 14, coupled to a customer computer 10 and an aircraft provider computer 26. Customer computer 10 and aircraft provider computer 26 may each be coupled to service provider computer system 14 via the Internet. Private charter aircraft auction system 9 further comprises a database 32 comprising aircraft availability information.

Customer computer 10 comprises a web browser 12. Aircraft provider computer 26 comprises a web browser 28 and a communication application 30. In a preferred embodiment of the present invention, the communication application is electronic mail (email). Service provider computer system 14 comprises an auction interface 16, a bidding interface 18, an alert mechanism 20, a query mechanism 22, a refinement mechanism 24, and a transaction process 17.

In operation, a user will operate customer computer 10, and enter a trip itinerary through the use of web browser 12. Specifically, auction interface 16 of service provider computer system 14 will present an auction interface on web browser 12 of customer computer 10, and the user of customer computer 10 will input certain information regarding a trip itinerary concerning the user's desire to travel from one location to another via a private charter aircraft. The trip itinerary comprises departure and destination locations, dates of travel, and a requested aircraft type.

An aircraft availability mechanism obtains aircraft availability information from a database comprising aircraft availability information in the form of a set of available aircraft and corresponding aircraft providers.

Aircraft availability information may comprise aircraft type, current location of the aircraft, aircraft provider contact information, an aircraft repositioning schedule, and an aircraft seating configuration. Aircraft type may comprise information regarding the size of the aircraft and the type of aircraft, for example, a small jet, a medium jet, or a small turbo-propeller aircraft. Information regarding the current location of the aircraft may comprise a specific airport location, or a larger area. For example, the current location of an aircraft could be Logan Airport in Boston, Mass., or more generally just Boston, Mass. More specific location information could be provided, such as, e.g., the distance in miles or travel time to the nearest airport, as well as the identification of the nearest airport. Aircraft provider contact information may comprise the name of the aircraft provider, an email address, a telephone number, a mailing address or any other type of communication address. An aircraft repositioning schedule comprises information about the scheduled movements of the aircraft over a period of time. Aircraft seating configuration information may comprise information regarding the number of seats on the aircraft and how these seats are configured.

In one embodiment, the aircraft availability mechanism comprises a query mechanism 22, which sends a query to a database 32, which contains information about aircraft availability. A query is sent to the database when new trip itinerary information is received, or when new aircraft availability information is received. Database 32 returns a response of a set of available aircraft that can fulfill the given trip itinerary to service provider computer system 14, where it is processed by a refinement mechanism 24. Refinement mechanism 24 takes the set of available aircraft that was returned by database 32 and produces a smaller set of available aircraft for the given trip itinerary based on suitability criteria. The smaller set of available aircraft is obtained by eliminating available aircraft based on the suitability criteria.

The aircraft providers of the smaller set of available aircraft are contacted by an alert mechanism 20. The eliminated aircraft are not contacted by alert mechanism 20. Alert mechanism 20 sends a communication alert to the aircraft providers to inform them that they are a suitable match to fulfill the given trip itinerary. In a preferred embodiment of the present invention, the communication alert is an email alert.

This communication alert is sent to communication application 30 within an aircraft provider computer 26. The communication alert contains a link to a web-page where the aircraft providers can submit bids. In one embodiment, this link is a hyperlink. After viewing the communication alert, the aircraft providers decide whether or not to submit a bid on the given trip itinerary. A web browser 28 within aircraft provider computer 26 allows the aircraft provider to submit a bit to a bidding interface 18 within service provider computer system 14. These bids are passed along to the web browser 12 of the customer computer 10 through auction interface 16. The bids can be viewed by the customer in real-time.

A transaction process 17 processes the transaction if the customer chooses one of the bids. A notification mechanism contacts the aircraft provider by a communication mechanism which sends communication to the communication address provided in the aircraft availability information. This communication notifies the aircraft provider that their aircraft has been chosen to fulfill the given trip itinerary. A confirmation mechanism contacts the customer by a communication mechanism which sends communication confirming the flight information and the booking of the aircraft. A transaction mechanism processes the payment for the flight from the customer.

“Communication” as used herein with respect to communication, communication application and communication alert includes, but is not limited to, electronic mail (email), instant messaging, use of a personal digital assistant (PDA), a pager, a fax, a cellular telephone, a conventional telephone, television, video telephone conferencing display, other types of radio wave transmitter/transponders and other forms of electronic communication. In a preferred embodiment of the present invention, communication refers to email. Those skilled in the art will recognize that other forms of communication known in the art are within the spirit and scope of the present invention.

The database may be implemented using Microsoft SQL Database. Visual Basic net programming may also be used to implemented this system.

A fractional private aircraft auction system and method is described in the Assignee's co-pending patent application U.S. Ser. No. 00/000,000 filed Jul. 23, 2004 (Attorney Docket No. 18148/2012), and the entirety of this application is hereby incorporated herein by reference.

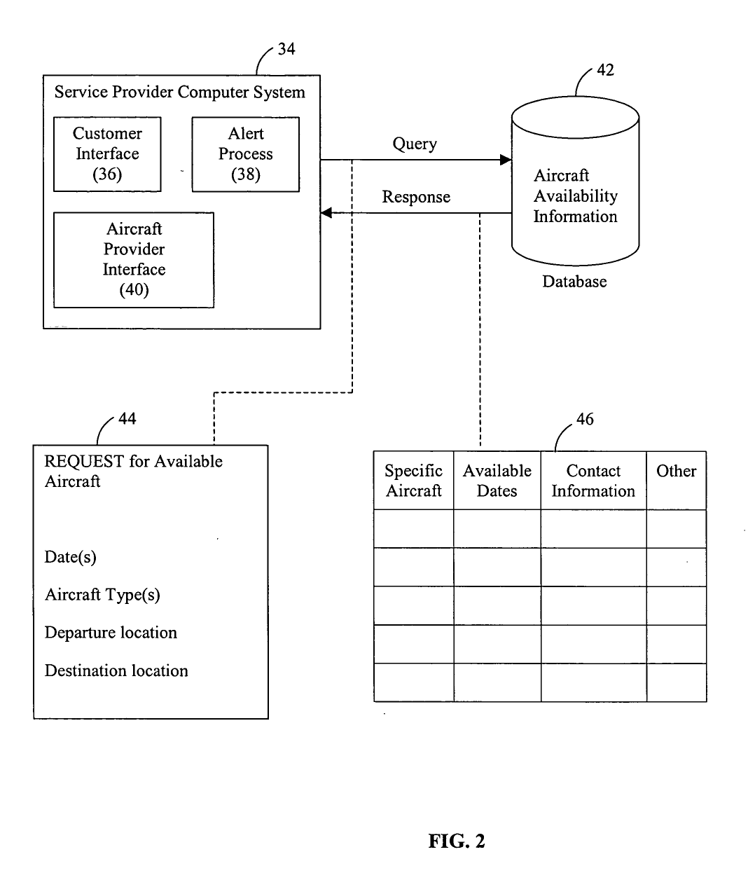

FIG. 2 shows an example of an embodiment of a query and response of the service provider computer system 34 and database 42. A query is sent from service provider computer system 34 to database 42. The query comprises a request for available aircraft 44. Request for available aircraft 44 has information regarding a given trip itinerary, including the date(s) of travel, the aircraft type(s) that are preferred by the customer, the departure location, and the destination location. The request for available aircraft 44 is sent to database 42. Database 42 returns a response, which is a set of the available aircraft that fit the criteria set forth in request for available aircraft 44. A set of available aircraft 46 is returned to service provider computer system 32 that contains information from database 42 about each aircraft in the set, including the specific type of aircraft, the available dates of that aircraft, the contact information for the aircraft provider, and any other information given by the aircraft provider that is stored in database 42.

Available aircraft are listed in response to the itinerary requests in the form of bids submitted by aircraft providers through the use of aircraft provider computer 26. Specifically, a bidding interface 18 is manifested through the use of the aircraft provider computer web browser 28. The bids are seen by the customer through the use of bidding interface 18 of service provider computer system 14, which will present the bid submissions on web browser 12 of customer computer 10.

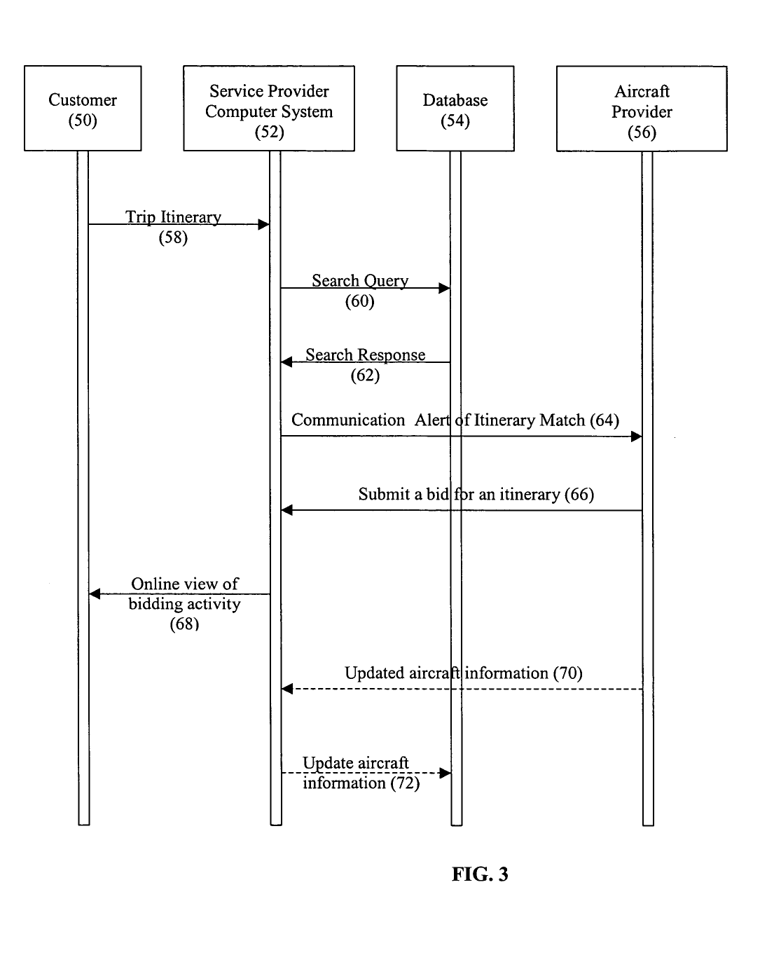

FIG. 3 shows the interactions between the different systems in the private charter aircraft auction. A customer 50 interacts with a service provider computer system 52 by sending a trip itinerary 58. The customer 50 receives the bidding activity information 68 from the service provider computer system 52. The interaction between the service provider computer system 52 and database 54 is in the form of a query 60 to the database, and a search response 62 from database 54 to service provider computer system 52. Service provider computer system 52 also sends database 54 updated aircraft availability information 72. Service provider computer system 52 sends communication alerts 64 to an aircraft provider 56. The aircraft provider 56 submits bids for an itinerary 66 to service provider computer system 52, as well as updated aircraft availability information 70.

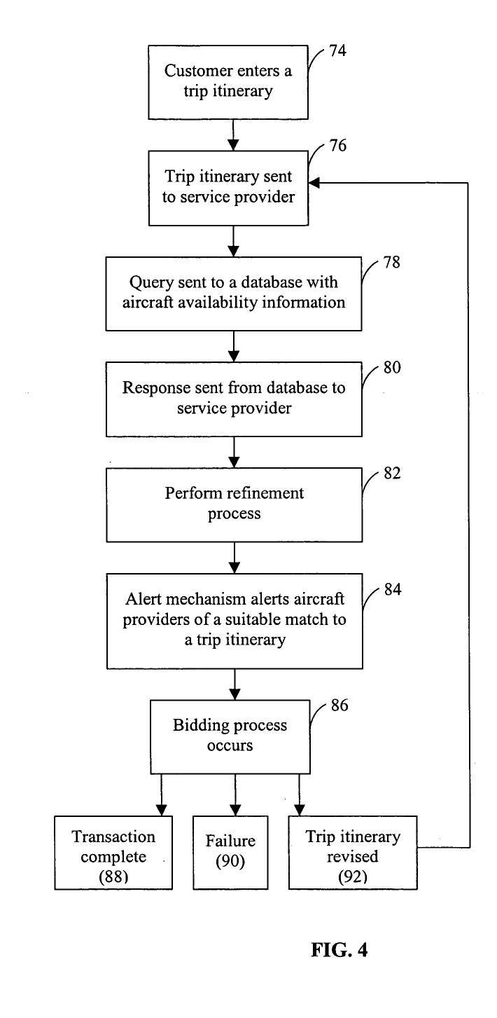

FIG. 4 is a flow diagram of a private charter aircraft auction process performed by service provider computer system 14. In act 74, the customer enters the trip itinerary, and the trip itinerary is sent to the service provider in act 76. A query is sent to the database containing aircraft availability information in act 78. In act 80, a response is sent from the database to the service provider that contains a set of available aircraft. In act 82, a refinement process is performed on the set of available aircraft. This process refines the set of available aircraft into a smaller set based on certain suitability criteria. The aircraft providers in the smaller set are alerted that they are a suitable match for the given trip itinerary in act 84.

A bidding process occurs in act 86. During the bidding process, the aircraft providers submit bids on the given trip itinerary, which are seen by the customer in real-time. The bidding process occurs for a certain set period of time. After this period of time has ended, the customer has the option of selecting one of the bids. In act 88, the customer selects one of the bids, and the transaction is completed. In act 90, there is a failure and the transaction is not completed, or the customer does not select one of the bids and ends the auction process. In act 92, the customer does not select one of the bids, but instead revises their trip itinerary, which sends a new query to the database.

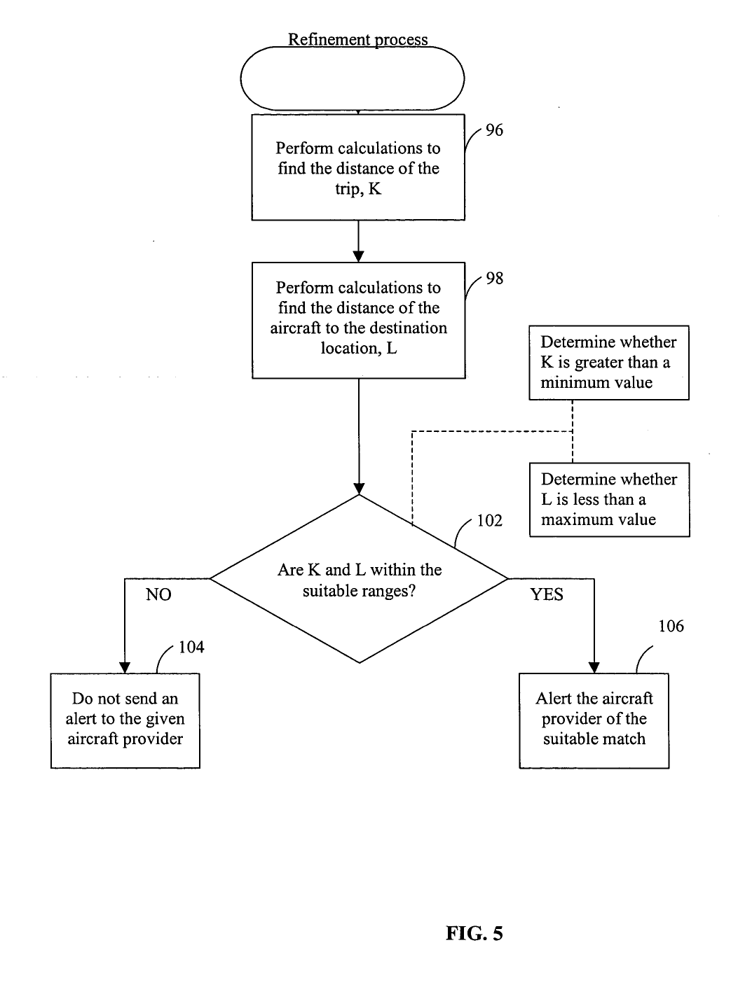

FIG. 5 shows a more detailed view of an embodiment of the refinement process which refines the set of available aircraft from the database response to a smaller set of available aircraft based on suitability criteria. Calculations are performed in order to find the distance between the departure and destination locations, K, in act 96. In act 98, calculations are performed in order to find the distance between the current location of the aircraft and the destination location, L. The value L is calculated for each aircraft on the list of available aircraft from the database, while the value K is calculated once for each trip itinerary. The values K and L are compared to desired ranges of such values. In the embodiment, if the calculated K is greater than a minimum value for K, and also L is less then a maximum value for L, (a determination made in act 102) then that aircraft provider would be added to the refined list of available aircraft.

For example, an aircraft provider X can set L to 50 miles, meaning that the maximum distance between the aircraft location and the destination location can be no more than 50 miles. If the distance is less than 50 miles, aircraft provider X would be added to the refined set of available aircraft. Aircraft provider X can also set K to 70 miles, meaning that the minimum flight distance that aircraft provider X will travel is 70 miles. So if the distance between the trip departure location and destination location is greater than 70 miles, aircraft provider X will be added to the list of available aircraft.

In act 102, a test is done for each aircraft to determine if they are a suitable candidate for fulfilling a given trip itinerary. If they are not a suitable candidate, they are not added to the refined smaller set of available aircraft and are not contacted about the given trip itinerary. If they are a suitable candidate, they are added to the refined smaller set of available aircraft and are contacted by the alert mechanism about the given trip itinerary.

Setting values for K and L ensures that only the most suitable candidates for a given trip itinerary will be contacted. The communication alerts received by the aircraft providers will therefore be more relevant, and they are more likely to pay attention to the alerts and submit bids for those trip itineraries.

The processing performed by the system described herein may be integrated into dispatching software. Dispatching software provides a continuous communication link to facilitate the charter aircraft auction. Dispatching software is used for scheduling of the aircraft and quoting the aircraft. Quoting the aircraft involves using software to load into the database all of the aircraft specifications, such as speed of the aircraft, the cost of the fuel and all the other components.

The dispatching software downloads the list of trip itineraries and compares those trip itineraries against availability and automatically provides a quote for each itinerary. To submit a bid, the dispatching software downloads the requests for quotes (“RFQs”), compares the RFQs, and quotes them automatically. The user then chooses an itinerary out of all the possible matches and accepts the chosen bid.

The processing performed by the system described herein may be performed by a general purpose computer alone or in connection with a specialized processing computer. Such processing may be performed by a single platform or by a distributed processing platform. In addition, such processing and functionality can be implemented in the form of special purpose hardware or in the form of software being run by a general purpose computer. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

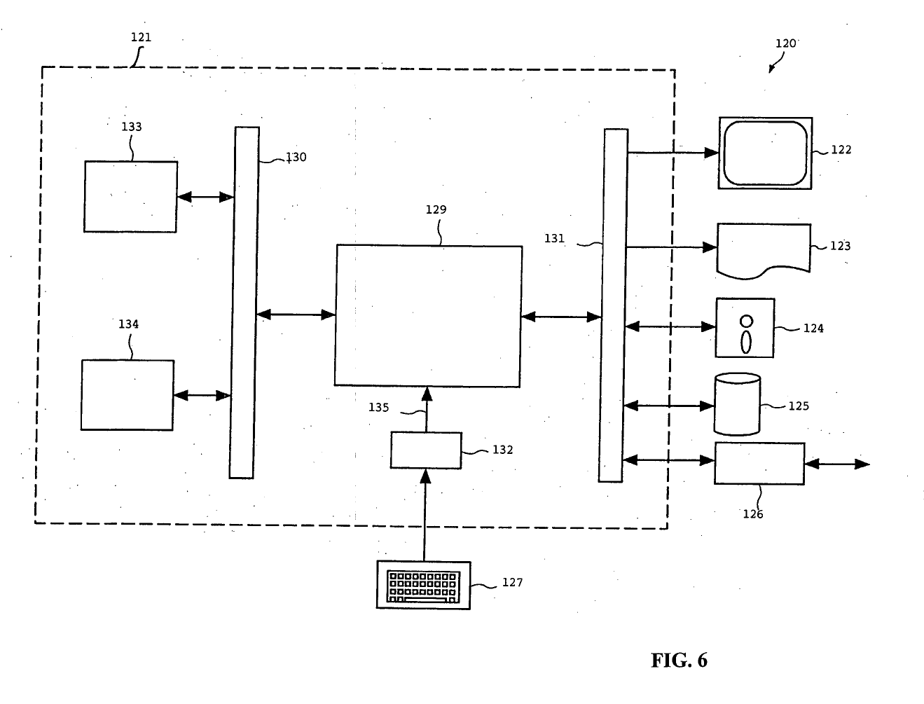

For example, a block diagram of a representative computer system 120 is shown in FIG. 6. In another embodiment of the present invention, the computer system is an embedded computer system. The computer system 120 includes a computer 121, a display screen (or monitor) 122, a printer 123, a floppy disk drive 124, a hard disk drive 125, a network interface 126 and a keyboard 127. The computer 121 includes a microprocessor 129, a memory bus 130, a peripheral bus 131 and a keyboard controller 132. The keyboard 127 is used by a user to input commands and other instructions to the computer system 120. The keyboard controller 132 receives input from the keyboard 127 and sends decoded symbols for each pressed key of the keyboard 127 to the microprocessor 129 over a bus 135. The computer 121 can be a personal computer, a workstation or some other type of computer.

The microprocessor 129 controls the operation of the computer system 120. The microprocessor 129 uses instructions received from memory and outputs and displays the data on output devices. The keyboard 127 is used by a user to input commands and other instructions to the computer system 120. The memory bus 130 is used by the microprocessor 129 to access a random access memory (RAM) 133 and a read only memory (ROM) 134. The RAM 133 is used by the microprocessor 129 as a general storage area and the ROM 134 is used to store the instructions or program code followed by the microprocessor 129. The computer code and data may reside on the RAM 133, the ROM 134, the hard disk drive 125 or a removable program medium that can be loaded or installed on the computer system 120.

The peripheral bus 131 is used to access the input, output and storage devices used by the computer 121. These input, output and storage devices include, but are not limited to, the display screen 122 the printer 123, the floppy disk drive 124, the hard disk drive 125 and the network interface 126.

The display screen 122 displays images of the melting curve data provided by the microprocessor 129 via the peripheral bus 131 or provided by other components in the computer system 120. The printer 123 provides an image on a sheet of paper or a similar type of surface. Other output devices including, but not limited to, plotters or typesetters can be used in place of, or in addition to, the printer 123.

The floppy disk drive 124 and the hard disk drive 125 are used to store various types of data. The floppy disk drive 124 facilitates transporting the data to a separate computer system while the hard disk drive 125 allows fast access to large amounts of stored data. The network interface 126 is used to send and receive data over a network that is connected to other computer systems. Those skilled in the art will recognize that other persistent storage devices to store various types of data are known in the art and are within the spirit and scope of the present invention.

All patents, patent applications, and published references cited herein are hereby incorporated herein by reference in their entirety. While the invention has been described with reference to the certain illustrated embodiments, the words which have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather extends to all equivalent structures, acts, and materials, such as are within the scope of the appended claims.

1. A system for auctioning private charter aircraft, where a customer enters a trip itinerary request and where aircraft providers submit bids on the trip itinerary, the system comprising:
an online auction interface to receive the trip itinerary request from the customer;
an aircraft availability mechanism to obtain, from an aircraft availability database comprising aircraft availability information, a set of available aircraft and corresponding aircraft providers to serve the trip itinerary request;
a refinement mechanism to eliminate some of the set of available aircraft based on suitability criteria to produce a smaller set of available aircraft for the trip itinerary request;
an alert mechanism to alert the aircraft providers corresponding to the smaller set without alerting the aircraft providers corresponding to the eliminated available aircraft; and
an online bidding interface to receive a set of bid submissions from a responding set of aircraft providers from among the alerted aircraft providers, the responding set of aircraft providers being those aircraft providers corresponding to the smaller set that voluntarily choose to respond to the alert by accessing the online bidding interface.

2. The system according to claim 1, wherein the online auction interface comprises a web browser on a customer computer.

3. The system according to claim 1, wherein the online auction interface comprises an auction interface on an auction computer server.

4. The system according to claim 3, wherein the auction computer server is on a web server.

5. The system according to claim 1, wherein the aircraft availability information comprises aircraft type.

6. The system according to claim 1, wherein the aircraft availability information comprises the current location of the aircraft.

7. The system according to claim 1, wherein the aircraft availability information comprises aircraft provider contact information.

8. The system according to claim 1, wherein the aircraft availability information comprises an aircraft repositioning schedule.

9. The system according to claim 1, wherein the aircraft availability information comprises an aircraft seating configuration information.

10. The system according to claim 1, wherein the alert mechanism comprises a communication mechanism to communicate with aircraft providers at a communication addresses determined from the aircraft availability database.

11. The system according to claim 10, wherein the communication mechanism communicates with the aircraft providers by email at an email addresses determined from the aircraft availability database.

12. The system according to claim 10, wherein the communication to the aircraft providers comprises a link to a webpage where online bid submissions are placed.

13. The system according to claim 12, wherein the link to the webpage where online bid submissions are placed comprises a hyperlink.

14. The system according to claim 1, wherein the online bidding interface comprises a web browser on a bidder computer.

15. The system according to claim 1, wherein the online bidding interface comprises a bidding interface on an auction computer server.

16. The system according to claim 15, wherein the auction computer server is on a web server.

17. The system according to claim 1, wherein an online bidding results interface allows the customer to view the bid submissions from aircraft providers.

18. The system according to claim 1, further comprising a transaction mechanism which processes a transaction for the customer and the customer's trip itinerary request when the customer completes the transaction by selecting one of the bid submissions from the aircraft providers.

19. The system according to claim 18, wherein the transaction mechanism comprises a confirmation mechanism which comprises a communication mechanism to communicate with customers at a communication addresses provided by the customer during the submission of the trip itinerary, confirming the booking of the aircraft for the trip itinerary.

20. The system according to claim 18, wherein the transaction mechanism comprises a notification mechanism which comprises a communication mechanism to communicate with the aircraft providers at communication addresses determined from the aircraft availability database, that the customer has selected their aircraft from the bid submissions to fulfill the trip itinerary.

21. The system according to claim 18, wherein the transaction mechanism comprises a payment mechanism that charges the customer the total cost of fulfilling the trip itinerary.

22. A method for auctioning private charter aircraft using aircraft availability information, where a customer enters a trip itinerary request online and aircraft providers submit bids on the trip itinerary, the method comprising:
receiving, at an online auction interface, trip itinerary requests from customers;
obtaining, from an aircraft availability database comprising aircraft availability information, a set of available aircraft and corresponding aircraft providers to serve the trip itinerary request;
eliminating some of the set of available aircraft based on suitability criteria to produce a smaller set of available aircraft for the trip itinerary request;
alerting the aircraft providers corresponding to the smaller set without alerting the aircraft providers corresponding to the eliminated available aircraft; and
receiving, at an online bidding interface, a set of bid submissions from a responding set of aircraft providers from among the alerted aircraft providers, the responding set of aircraft providers being those aircraft providers corresponding to the smaller set that voluntarily choose to respond to the alert by accessing the online bidding interface.

23. The method according to claim 22, wherein the trip itinerary is posted on an online auction interface comprising a web browser on a customer computer.

24. The method according to claim 22, wherein the trip itinerary is posted on an online auction interface comprising an auction interface on an auction computer server.

25. The method according to claim 24, wherein the auction computer server is on a web server.

26. The method according to claim 22, wherein the database contains information regarding the aircraft type.

27. The method according to claim 22, wherein the database contains the current location of the aircraft.

28. The method according to claim 22, wherein the database contains aircraft owner/operator contact information.

29. The method according to claim 22, wherein the database contains aircraft repositioning schedules.

30. The method according to claim 22, wherein the aircraft availability information comprises an aircraft seating configuration information.

31. The method according to claim 22, wherein the database search runs automatically when a new trip itinerary is posted.

32. The method according to claim 22, wherein the database search runs automatically when new availability information is supplied by the aircraft providers.

33. The method according to claim 22, wherein the aircraft providers are alerted by a communication to a communication address determined from the aircraft availability information.

34. The method according to claim 33, wherein the aircraft provides are alerted by email to an email address determined from the aircraft availability information.

35. The method according to claim 33, wherein the communication to the aircraft providers comprise a link to a webpage where online bid submissions are placed.

36. The method according to claim 35, wherein the link to a webpage where online bid submissions are placed comprises a hyperlink.

37. The method according to claim 22, wherein the decision to place a bid on a trip itinerary is solely made by the aircraft providers.

38. The method according to claim 22, wherein the bid submission is placed on an online bidding interface comprising a web browser on a bidder computer.

39. The method according to claim 22, wherein the bid submission is placed on an online bidding interface comprising a bidding interface on an auction computer server.

40. The method according to claim 39, wherein the auction computer server is on a web server.

41. The method according to claim 22, further comprising the customer selecting one of the bid submissions from the aircraft providers to process a transaction for the trip itinerary request.

42. The method according to claim 41, further comprising booking an aircraft for the trip itinerary by sending a communication to the customer at a communication address of the customer.

43. The method according to claim 41, further comprising notifying the aircraft provider that the customer has selected the aircraft of the aircraft provider from the bid submissions to fulfill the trip itinerary by sending a communication to a communication address determined from the aircraft availability database.

44. The method according to claim 41, further comprising paying the charges of the total cost of fulfilling the trip itinerary by the customer.

45. An alert apparatus for alerting aircraft providers when they are a suitable candidate to place online bids in response to a customer trip itinerary of a private charter aircraft customer, the alert apparatus comprising:
a suitability determination mechanism to determine for the customer trip itinerary, from a database containing aircraft availability information regarding the availability of private charter aircraft and based on suitability criteria, a limited set of available aircraft and corresponding aircraft providers; and
an alerting mechanism to alert the corresponding aircraft providers and invite the corresponding aircraft providers to submit bids on the customer trip itinerary.

46. The alert apparatus according to claim 45, wherein the suitability criteria comprises a calculation mechanism to calculate the distance from the location of the aircraft to the departure location from the trip itinerary.

47. The alert apparatus according to claim 46, wherein the calculation mechanism calculates the distance from the departure location to the destination location from the trip itinerary.

48. The alert apparatus according to claim 45, wherein the calculation mechanism uses latitude and longitude information for the distance calculations.

49. The alert apparatus according to claim 45, wherein the alert mechanism comprises a communication mechanism to communicate with the aircraft providers at communication addresses determined from the aircraft availability database.

50. The alert apparatus according to claim 47, wherein the communication mechanism to the aircraft providers comprises a link to a webpage where online bid submissions are placed.

51. The alert apparatus according to claim 50, wherein the link to a webpage where online bid submissions are placed comprises a hyperlink.

52. A computer readable medium containing program instructions for auctioning private charter aircraft comprising:
program instructions for receiving itinerary requests from customers with an online auction interface;
program instructions for obtaining, from an aircraft availability database comprising aircraft availability information, a set of available aircraft and corresponding aircraft providers to serve a trip itinerary request from an aircraft availability mechanism;
program instructions for eliminating some of the set of available aircraft to produce a smaller set of available aircraft for the trip itinerary request from a refinement mechanism;
program instructions for alerting the aircraft providers corresponding to the smaller set without alerting the aircraft providers corresponding to the eliminated available aircraft from an alert mechanism;
program instructions for receiving a set of bid submissions from a responding set of aircraft providers from among the alerted aircraft providers from an online bidding interface, the responding set of aircraft providers being those aircraft providers corresponding to the smaller set that voluntarily choose to respond to the alert by accessing the online bidding interface.
